(19) United States
(12) Patent Application Publication
(10) Pub. No.: US 2012/0092248 A1
(43) Pub. Date: Apr. 19, 2012

(54) METHOD, APPARATUS, AND SYSTEM FOR ENERGY EFFICIENCY AND ENERGY CONSERVATION INCLUDING DYNAMIC USER INTERFACE BASED ON VIEWING CONDITIONS

(76) Inventor: Sasanka Prabhala, Beavercreek, OH (US)

(21) Appl. No.: 13/336,514

(22) Filed: Dec. 23, 2011

(51) Int. Cl. G09G 5/00; G06F 13/14

(52) U.S. Cl. 345/156; 345/520

(57) ABSTRACT

In general, in one aspect, a viewing configuration detector collects data for a viewing area of a consumer electronics device and determines viewing configuration based on the collected data. A dynamic user interface controller determines a perceived appropriate configuration for the content presented on the consumer electronics device based on the viewing configuration and if necessary modifies the configuration of the content. The modifying is done without receiving input to make the change from a user and may be done to conserve power or enhance user experience. The viewing configuration detector may include a light transmitter to transmit light in direction of the user and a light receiver to receive reflected light and determine distance and/or location of user based theeron. The viewing configuration detector may include a camera to capture images of the viewing area and image recognition functionality to detect the user and different attributes associated therewith.

### BACKGROUND

Consumer electronic devices continue to increase the functionality they provide and the content that can be viewed thereon. For example, consumer electronics devices such as media players (e.g., iPod Touch), smart phones (e.g., iPhone, Blackberry, Android phone, Windows phone), tablets (e.g., iPad), computers (e.g., lap-tops, desk tops), and televisions may enable users to perform at least some subset of viewing video, running one or more applications, and connecting to the Internet. The videos may be, for example, loaded on/downloaded to the device, streamed over the Internet, provided via a media (e.g., DVD) or received via a content delivery provider/network (e.g., cable, satellite). The applications running thereon and the Internet connections may provide content (e.g., text, graphics) in various different forms (e.g., windows, screens, tabs, icons).

The devices may have default configurations for how content is presented to the user (e.g., location, text size). The devices may enable the user to configure how they would like the content to be presented based on their preferences. Depending on different situations (e.g., distance from device) the default/initial configurations may not be suitable. For example, if the user is far away from the device the initial/default text size may be too small, the amount of space on the display allocated to the content (e.g., small window in corner of screen, right ⅓ of screen, top ½ of screen) may be too small, and the luminosity may not be optimized. The text may be associated with, for example, an electronic program guide for content available on a television, content associated with applications running thereon, or content received via the Internet.

The device may enable the user to change the configuration as desired. The configuration change may be made using a user interface for the device. The user interface may be a separate component (e.g., remote control), be integrated in the device (e.g., buttons on the device) and/or be integrated into device's display (touch screen). The user interaction required to change the initial/default parameters may be cumbersome for the user. Accordingly, the user may limit the changes that they make and not optimize their experience, power savings (and battery life for mobile devices), or the like do to the difficulty in changing parameters.

### BRIEF DESCRIPTION OF THE DRAWINGS

The features and advantages of the various embodiments will become apparent from the following detailed description in which:

FIG. 1 illustrates a high level functional diagram of an example consumer electronics device;

FIG. 2A illustrates a high level diagram of an example consumer electronics device having viewing configuration (distance) detection and automatic content configuration update functionality, according to one embodiment;

FIG. 2B illustrates a high level diagram of an example consumer electronics device having enhanced viewing configuration detection and automatic content configuration update functionality, according to one embodiment;

FIGS. 3A-B illustrates example configuration zones based on distance a user is from a device, according to one embodiment;

FIGS. 4A-B illustrate example configuration zones based on location of a user with respect to a device according to one embodiment;

FIG. 5 illustrates an example high level flowchart of the example device of FIG. 2A incorporating a dynamic user interface controller, according to one embodiment;

FIG. 6 illustrates an example high level flowchart of the example device of FIG. 2B incorporating a dynamic user interface controller, according to one embodiment;

FIG. 7 illustrates several relatively simple examples of changes to content configuration being displayed, according to one embodiment;

FIG. 8 illustrates an example content display system, according to one embodiment; and

FIG. 9 illustrates an example small form factor device in which the system of FIG. 8 may be embodied, according to one embodiment.

### DETAILED DESCRIPTION

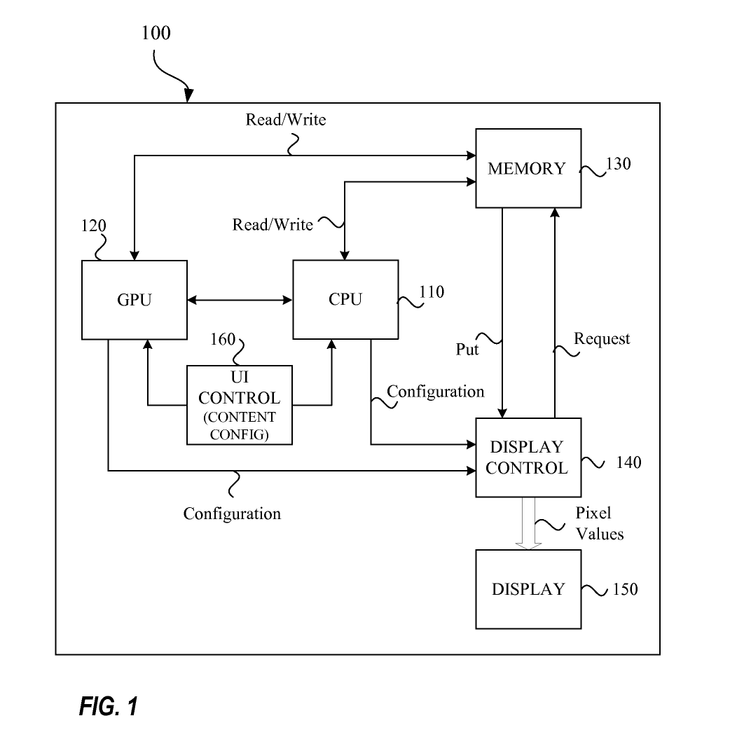

FIG. 1 illustrates a high level functional diagram of an example consumer electronics device 100. The device 100 may include a processor (CPU) 110, a graphics processor (GPU) 120, memory 130, a display controller 140, a display 150, and a user interface controller (content configurater) 160. The CPU 110 may control the operations of the device 100. The CPU 110 may execute applications that generate content for presentation and/or may process content (e.g., video, pictures) to be presented. The CPU 110 reads and writes data to the memory 130. The data written to the memory 130 may include information (e.g., pixels) related to content to be presented on the display 150. The memory 130 may include a frame buffer (not separately illustrated) for storing the information for the content to be presented on the display 150.

The GPU 120 may execute applications that generate content (e.g., graphics) for presentation and/or may process graphics for the CPU 110. The graphics may be independent (e.g., video game) or may be for use with other content (e.g., graphical overlay). The GPU 120 may receive instructions from the CPU 110. The GPU 120 reads and writes data to the memory 130.

It should be noted that while the CPU 110 and GPU 120 are illustrated as being separate and described as performing different functions that the device 100 is not limited thereto. For example, in some cases the CPU 110 and the GPU 120 can co-exist and perform the same tasks and in some cases a single device (CPU 110 or GPU 120) may be utilized to perform the operations described with respect to both.

The display controller 140 controls the writing of the content on the display 150. The display controller 140 may be configured by the CPU 110 and/or the GPU 120 based on the content to be displayed. The display controller 140 fetches the information for the content to be presented from the memory 130 (fetch illustrated as request and put). The display controller 140 decodes the information (e.g., pixels) to determine output pixel values for the display 150 and transmits the pixel values to the display 150. The display 150 utilizes the pixel values to present the content thereon.

The user interface controller 160 may receive input from a user via a user interface (e.g., remote control, on screen menu) and provide instructions to the CPU 110 and/or the GPU 120 based on the user input. The CPU 110 and/or the GPU 120 may modify the content being prepared for presentation based on the instructions. The user input may be related to the content to be presented (e.g., switch channels on a television) or changes to the configuration (e.g., increase text size) of the content being presented. The user may change the configuration for various reasons including, for example, changes in viewing conditions (e.g., distance from device). For example, if the user is far enough away from the device 100 that they are having trouble reading the text being presented, they may increase the size of the text being presented. The user may find changing the configuration to be difficult and thus may limit these changes.

According to one embodiment, the device 100 may be able to detect viewing configurations (function not illustrated). The viewing configurations may be, for example, distance from the device. The device 100 may be able to make changes to the configuration of the content based on the detection of viewing configurations without the need for user interaction (e.g., determination that user is far enough away from device that text size should be increased). The user interface controller 160 may determine what content configuration changes to make or additional functionality (not illustrated) may make the determination and dynamically generate user interface commands and provide them to the user interface controller 160. Such an embodiment may eliminate or reduce the need for the user to make the configuration changes via the user interface. Furthermore, additional configuration changes may be made that a user would not make that may increase a user's experience (e.g., increase font size) and/or save power and battery life for mobile device (e.g., reduce luminosity). The user could change or reject configuration changes automatically made by the device 100.

It should be noted that many functions (e.g., power, communications) are not included for ease of illustration. Furthermore, different devices may include various additional functional blocks that are not illustrated as they may not be associated with all devices. For example, a television may include video decoders. The functional blocks illustrated are not necessarily related to specific components in the device 100. Rather a single component may be associated with multiple functional blocks, multiple components may be associated with a single functional block, or some combination thereof

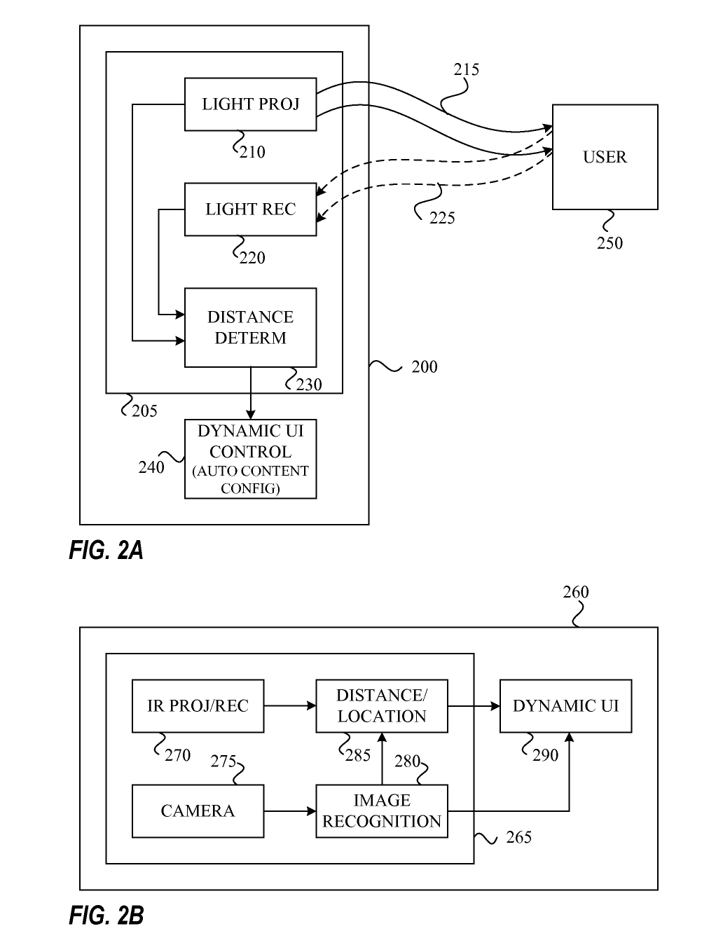

FIG. 2A illustrates a high level diagram of an example consumer electronics device 200 having viewing configuration (distance) detection and automatic content configuration update functionality. The device 200 may include viewing configuration detection functionality 205 and a dynamic user interface controller (automated content configurater) 240. The viewing configuration detection functionality 205 may include a light (e.g., infrared (IR)) projector 210, a light (e.g., IR) receiver 220, and a distance determiner 230. The light projector 210 is to transmit light 215 away from the display in a direction towards where a user 250 viewing content presented on the device 200 would be located. The light receiver 220 is to receive the light 225 that reflects back (including light reflected from the user 250). The distance determiner 230 is to receive data related to the light transmitted 215 and the light received 225 from the light projector 210 and the light receiver 220 respectively and determine the distance the user is from the device 200 based thereon. The distance determiner 230 may be able to determine what reflected light received is related to the user 250 as opposed to other objects.

According to one embodiment, the reflected light received from an empty room associated with the device (e.g., room with which a television is located) may be captured and provided to the distance determiner 230 as a baseline configuration. The distance determiner 230 may detect changes in the reflected light received and utilize the changes to determine distance of a user.

The viewing configuration detection functionality 205 may be part of (built in) the device 200. Alternatively, the viewing configuration detection functionality 205 may an external device (or devices), that is connected to the device 200.

The dynamic user interface controller 240 is to receive the distance from the distance determiner 230 and determine if changes should be made to the content configuration and what those changes should be. This may involve determining what a perceived appropriate content configuration is for the viewing conditions and comparing the perceived appropriate content configuration to the actual content configuration. The changes may be based on the content that is being presented. For example, if the content includes text, the changes may be to increase (or decrease) the text size based on distance the user is away from the device 200. The changes may be made based on specific parameters defined in advance by the user or determined by the controller 240. For example, increase the font size to 14 point at a distance greater than six feet and to 16 point at a distance greater than 12 feet. The configuration changes may be modifications to the initial/default configuration (e.g., increase font 10% at 6 feet) that are user defined and/or controller 240 generated. The user may change any configuration change that is automatically made, whether the change was made based on user criteria and/or the controller 240. The user may turn off the automatic configuration change functionality.

The controller 240 may determine content configuration changes based on heuristics associated with various viewing configurations (where the heuristics may be associated with a generic user). The heuristics may be adjusted based, for example, on initial configurations defined by the user (e.g., user set initial font as 12 point where default font is 10 point). The controller 240 may determine content configuration changes by, for example, capturing the viewing configurations for different content configurations, viewing configurations (or changes thereto) when the user makes content configuration changes, and learning the content configuration associated with different viewing configurations. When the controller 240 detects certain viewing configurations it may change the content configuration to what it has learned is associated therewith.

The changes are not limited to changes to font size as noted above. Rather any number of changes to the configuration of the content being presented can be made. For example, the size and/or location of media controls, electronic program guides (EPG), Internet search windows, or the like that may be overlaid on top of the content, may be displayed over a portion of the content (e.g., bottom half of content is covered by EPG) or may be displayed in conjunction with the content (e.g., content is shrunk to fit on right half of display and Internet search window is presented on left half) may be modified. If the default configuration for a user opening an Internet search on their Internet enabled television is a side menu that utilizes ⅓ of the green it may be modified to a side-by-side bar that utilizes half the screen if the user is more then a certain distance away.

By way of another example, the luminosity of the device 200 may be modified based on the distance of the user to the device 200. For example if the user is within a certain distance the luminosity may be turned down while still providing content at an acceptable brightness. Turning the luminosity down may conserve power and for mobile devices and/or battery operated devices may also conserve battery life. By way of another example, if the user is determined to be a certain distance away a determination may be made that the display quality can be reduced as the user is likely too far away to be able to notice the reduction in the quality of the content presented. Moreover, if the content includes audio the device 200 may increase the volume as the determination is made that the user is further away. Furthermore, if a determination is made that the user is not within a defined distance the device may dim or turn off the display to conserve power (similar to a display dimming and then turning off after periods of inactivity) and save battery life for mobile devices.

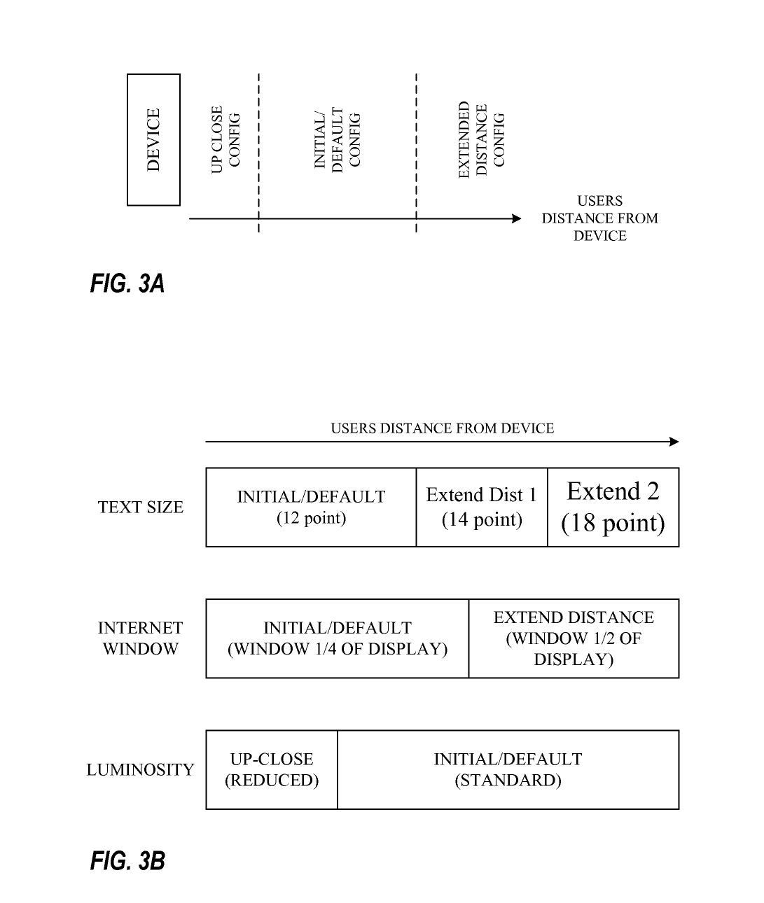

FIG. 3A illustrates example configuration zones based on distance a user is from a device. When a user initially starts viewing content on the device a default configuration or an initial configuration defined by a user is utilized. The initial/default configuration may be associated with a particular range of distances that the user is from the device. If the device determines that the user is closer to the device than this range, the device may enter a close-up configuration. If the device determines that the user is further away from the device than this range, the device may enter an extended distance configuration. It should be noted that the distances for changing from the initial/default setting may vary based on different configuration types. Furthermore, the different configuration types may have varying number of configuration changes defined.

FIG. 3B illustrates example configuration zones for several example configuration types based on distance the user is from the device. As illustrated, in addition to the initial/default text size configuration there are two extended distance text size configurations. The initial/default Internet window configuration is ¼ of the display which may change to ½ of the display if the user is more than a certain distance away from the display. The luminosity may have an initial/default setting and then a reduced setting if the user is closer than a certain distance from the device.

Referring back to FIG. 2, the distance determiner 230 may also be able determine the location of a user with respect to the device 200 based on input from the light projector 210 and the light receiver 220. The distance determiner 230 may be able to determine if the user is located in front of the display, to the right of the display or to the left of the display. The controller 240 is to receive the location from the distance determiner 230 and determine if changes should be made to the content configuration and what those changes should be.

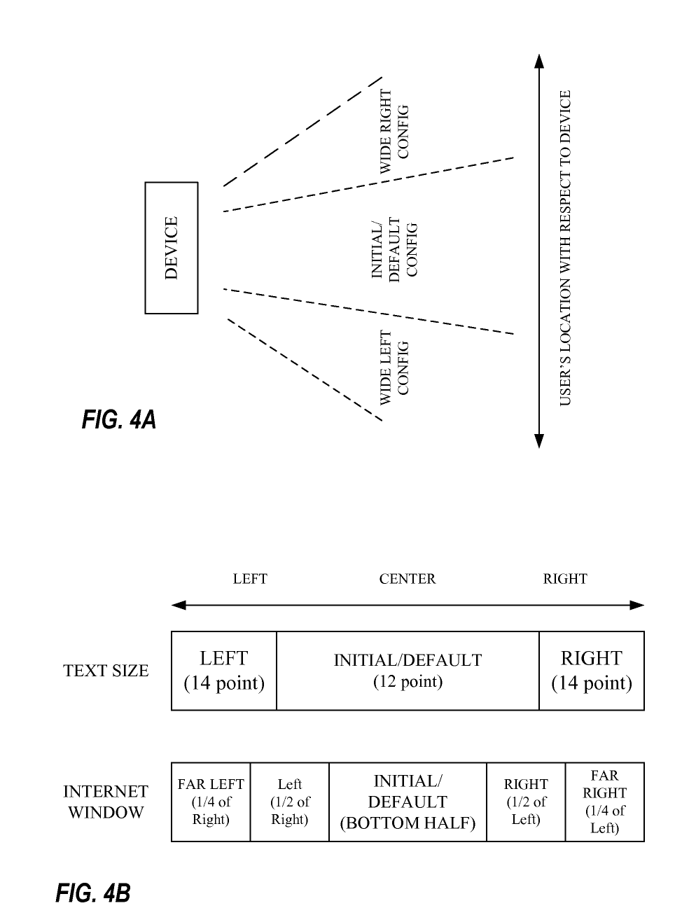

FIG. 4A illustrates example configuration zones based on location of a user with respect to a device. An initial/default configuration may be associated with a user being substantially in front to the device and this initial/default configuration may be utilized when a user initially starts viewing content on the device. If the device determines that the user is to the left of the device, the device may enter a wide left configuration and if the device determines that the user is to the right of the device, the device may enter a wide right configuration. It should be noted that the location for changing from the initial/default setting may vary based on different configuration types. Furthermore, the different configuration types may have varying number of configuration changes defined.

FIG. 4B illustrates example configuration zones for several example configuration types based on location of the user with respect to the device. As illustrated, in addition to the initial/default text size configuration there is a right and left configuration. The initial/default Internet window configuration is the bottom half of the display. When the location of the user is to the left the Internet window shifts to the right half of the display and when the user is to the far left the Internet window shifts the right ¼ of the display. Likewise, when the location of the user is to the right the Internet window shifts to the left half of the display and when the user is to the far right the Internet window shifts the left ¼ of the display.

The configuration types that may be changed, and the configuration zones and configuration changes in the zones for the various configuration types may be user defined, device generated (e.g., controller 240), or some combination thereof. The configuration types, configuration zones and configuration changes are not limited to the illustrated examples of FIGS. 3A, 3B, 4A and 4B. Rather various different configuration types, configuration zones and configuration changes are all within the current scope. For example, the configuration zones could be a combination of distance and location. By way of another example, the view (e.g., wide angle, close-up) of the content being presented may be a configuration type. The user may be capable of changing any configuration changes that are dynamically made regardless of whether they are user defined, device generated or some combination thereof

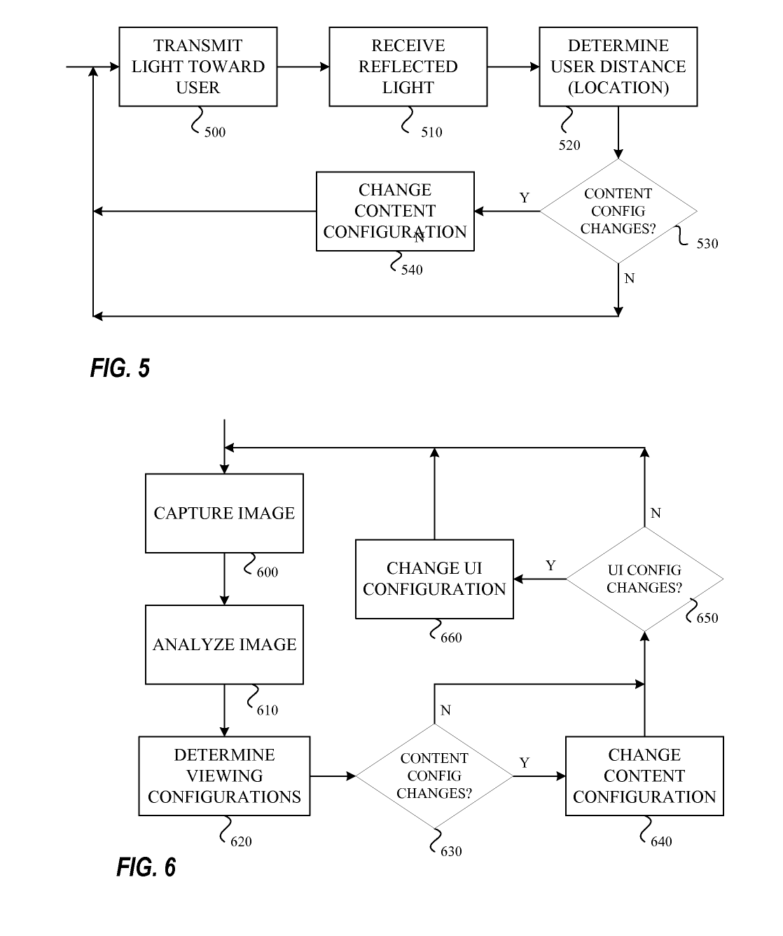

FIG. 5 illustrates an example high level flowchart of a device (e.g., 200 of FIG. 2A) incorporating a dynamic user interface controller (automatic content configuration). Initially, a user activates a device and selects content to view thereon (not illustrated). Once the device is activated, the light projector transmits light in the direction of a user 500 and the light receiver receives reflected light (including light reflected from the user) 510. Based on the reflected light received in response to the light transmitted, a determination is made as to the distance of the user from (and possibly location with respect to) the device 520.

The light transmission 500 and subsequent receiving 510 may be continuously performed. Alternatively, in order to conserve power and processing resources the light transmission 500 and subsequent receiving 510 may be performed intermittently. Once initiated, the transmission of the light 500 and the subsequent receipt of the reflected light 510 may be performed for a defined period or until enough data is collected to determine the distance and/or location of the user 520. The transmitting/receiving light sequence 500/510 may be reinitiated at defined intervals (e.g., every 5 minutes) or defined events (e.g., new content being presented, some type of change in the content being presented).

Once the distance/location are determined 520, a determination is made as to what content configuration changes should be made 530. As discussed above, the content configuration changes may have been predefined by the user, may be device generated, or some combination thereof. The content configuration changes may include, for example, zooming in, zooming out, increasing/decreasing text size, increasing/decreasing window size, moving location of windows, changing view, increasing/decreasing luminosity, increasing/decreasing volume, and changing quality of display output. If the determination is that content configuration changes should be made (530 Yes), the appropriate changes are made to the configuration of the content 540 and the revised content is presented to the user. The process continues with the light transmission 500. If the determination is that no content configuration changes are required (530 No), the process continues with the light transmission 500.

According to one embodiment, the device may be able to detect enhanced viewing configurations, such as, the number of users, the type of users (e.g., detect minors), the configuration of the users (e.g., how spread out are they), and a user's posture and/or actions as they interact with the device. The device may utilize, for example, a camera and image detection functionality to detect the enhanced viewing configurations. The enhanced viewing configurations may be used to adjust the content configuration and/or the user interface configuration (mode with which the user interacts with device, such as, touch or voice). Furthermore, the enhanced viewing configurations may be used in conjunction with distance/location determinations generated by other means (e.g., light projector 210 and light receiver 220 of FIG. 2A) to enhance the determination of distance/location.

FIG. 2B illustrates a high level diagram of an example consumer electronics device 260 having enhanced viewing configuration detection and automatic content configuration update functionality. The device 260 may include enhanced viewing configuration detection functionality 265 and a dynamic user interface controller (automated content configurater) 290. The enhanced viewing configuration detection functionality 265 may include a light (e.g., IR) projector/receiver 270, a camera 275, image recognition functionality 280, and distance/location functionality 285. The light projector/receiver 270 is to transmit light in the direction of the users and receive reflected light back. The camera 275 is to capture an image of the viewing area of the device. The image recognition functionality 280 is to analyze the image captured in order to detect and determine enhanced viewing configurations (above and beyond simply distance and/or location). For example, the image recognition functionality 280 may determine where a majority of the users are with respect to the device 260, that a minor is in the viewing area, or the posture and/or actions of the user. The distance/location functionality 285 is to determine the distance and/or location of users based on input from the light projector/receiver 270 and/or image recognition functionality 280.

According to one embodiment, a baseline image and/or reflected light patterns of an empty room associated with the device (e.g., room with which a television is located) are captured. The image recognition functionality 280 and/or the distance/location functionality 285 may detect changes to the baseline and use the changes to determine the viewing configurations.

The viewing configuration detection functionality 265 may be part of (built in) the device 260, may be an external device (or devices) that is connected to the device 260, or some combination thereof. For example, the light projector/receiver 270 may be built in the device 260 and the camera 275 may be externally connected (or vice versa). Any portion of the functionally provided externally may be provided by one or more devices (e.g., light projector/receiver 270 and camera 275 may be separate devices or may part of an integrated device).

The dynamic user interface controller 290 is to determine if content configuration changes should be made and if so what those changes are. This may involve determining what a perceived appropriate content configuration is for the viewing conditions and comparing the perceived appropriate content configuration to the actual content configuration. The controller 290 may make the determination based on input from the distance/location functionality 285 and/or the image recognition functionality 280. The changes may be the type described above. Furthermore, the determination of enhanced viewing configurations may provide the ability to implement additional configuration changes. For example, if it is determined that a majority of the users viewing the device are at a certain distance/location the content may be optimized for viewing at that distance/location. By way of another example, if it is determined that one of the users is a minor a message may be presented if inappropriate content is going to be presented or may modify the content so as to distort and/or block the inappropriate content. If it is determined that the only users are minors it may prevent inappropriate content from being viewed.

The changes may be made based on specific parameters defined in advance by the user or determined by the controller 290. The controller 290 may determine content configuration changes based on heuristics. The heuristics may be adjusted based, for example, on initial configurations defined by the user. The controller 290 may determine content configuration changes by, for example, learning previous actions of the user. The user may change any configuration change that is automatically made, whether the change was made based on user criteria and/or the controller 290. The user may turn off the automatic configuration change functionality.

The user may interact with the device 260 in a different manner based on how it is being used. For example, when a tablet is docked on the kitchen counter the interaction mode (user interface configuration) may be voice based or gesture based. Whereas, when the tablet is in the hands of the user the interaction mode may be touch based. The interaction mode may be typically configured by the user.

The controller 290 may also determine if the user interface configuration (interaction mode) should be dynamically changed. This may involve determining what a perceived appropriate user interface configuration is for the viewing conditions and comparing the perceived appropriate user interface configuration to the actual user interface configuration. The controller 290 may determine how the device is being used based on the viewing conditions and if the user interface configuration needs to be changed to support how the device is being used.

The image recognition functionality 280 may capture, for example, a users' posture (e.g., standing, sitting) or actions of the user (e.g., pointing finger, waving arms, nodding head) from an image captured by the camera 285. The various viewing configurations captured (e.g., posture, distance) may be used to make a determination of how the device is being used, what user interface configuration is associated with how the device is being used, and whether a change in user interface configuration is needed. The viewing configuration associations to use and/or user interface configuration may be defined in advance by the user or may be determined by the controller 290. The user may change any user interface configuration change that is automatically made, whether the change was made based on user criteria and/or was made by the controller 290. The user may turn off the automatic user interface configuration change functionality.

The controller 290 may determine how the device is being used and/or the appropriate user interface configuration based on heuristics associated with various viewing configurations (where the heuristics may be associated with a generic user). The controller 290 may determine user interface configuration changes by capturing the viewing configurations for different uses and the user interface configurations associated with the uses. The controller 290 may capture viewing configurations (or changes thereto) when user interface configuration changes are made. The controller 290 may learn the user interface configuration associated with different viewing configurations. When the controller 290 detects certain viewing configurations it may change the user interface configuration to what is has learned is associated therewith.

By way of example, it may be determined that when the user is interacting with a tablet in a docking station that they are typically standing and that they interface with the tablet via voice commands. If the controller 290 determines that the user is standing it may determine that the tablet is being used in a docking station and that when used in that manner it interacts with the user via voice commands. The controller 290 may accordingly change the user interface configuration to voice commands.

FIG. 6 illustrates an example high level flowchart of a device (e.g., 260 of FIG. 2B) incorporating a dynamic user interface controller (automatic content configuration). The flowchart focuses on the use of the camera and image recognition functionality as the light projector/receiver functionality was already discussed with respect to FIG. 5. It should be noted that the flowcharts of FIGS. 5 and 6 could be integrated to illustrate an example of the combined functionality.

Once the device is activated, the camera captures an image of the viewing area 600. The image recognition functionality analyzes the image 610 to determine viewing configurations 620. The image capture 600 and analysis 610 may be continuously performed. Alternatively, in order to conserve power and processing resources the image capture 600 and analysis 610 may be performed at defined intervals (e.g., every 5 minutes) or defined events (e.g., new content being presented, some type of change in the content being presented). Based on the determination of the viewing configurations 620, a determination is made as to what content configuration changes should be made 630. If the determination is that content configuration changes should be made (630 Yes), the appropriate changes are made to the configuration of the content 640 and the revised content is presented to the user.

If the determination is that no content configuration changes need to be made (630 No) or after any necessary content configuration changes are made 640, a determination may then be made as to whether user interface configuration changes should be made 650. If the determination is that user interface configuration changes should be made (650 Yes), the appropriate changes are made to the user interface configuration 660 and the process continues with the image capture 600. If the determination is that no user interface configuration changes are required (650 No), the process continues with the image capture 600.

The embodiments described above utilized camera's and/or light transceivers to capture data that is utilized to determine viewing configurations which are then utilized to determine content and/or user interface configuration changes. The collection of data is not limited thereby. Rather various types of data may be collected to determine viewing configurations. For example, sound transceivers may be utilized to transmit sound and receive the reflected sounds back and to use this data to determine viewing configurations (e.g., location of a user) or temperature sensors may be utilized to determine an approximate number of users in the room.

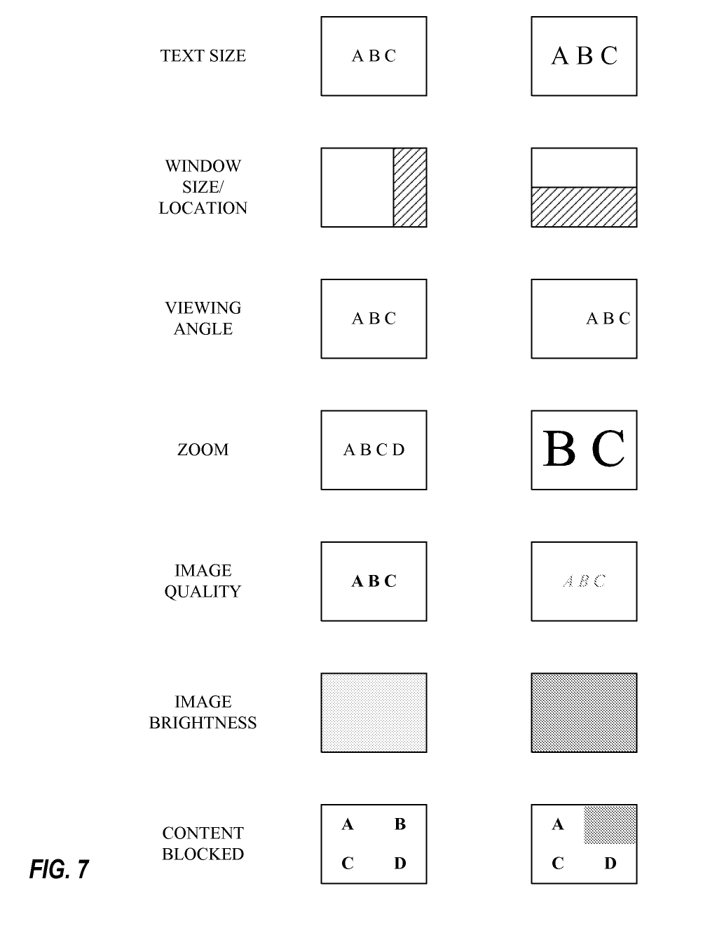

FIG. 7 illustrates several relatively simple examples of changes to content configuration being displayed. The text size example shows the size of the text being increased. The window size/location example illustrates the window shifting from 25% of the right of the display to 50% of the bottom. The viewing angle example shows the viewing angle rotating to the right. The zoom example illustrates the display zooming in on the content in the center of the display. The image quality example sows the quality being reduced. The image brightness example shows the brightness of the display being reduced. The content blocking example shows the content in the upper right being blocked out (or distorted).

The dynamic user interface functionality described above in FIGS. 2-7 may be implemented, for example, in a CPU (e.g., 110 of FIG. 1), a GPU (e.g., 120 of FIG. 1), a display controller (e.g., 140 of FIG. 1), an integrated circuit, circuitry or discrete components that are part of the device or some combination thereof. Furthermore, the operations may be implemented in hardware, software, firmware or some combination thereof. The CPU, GPU, and/or display controller may have access to device readable storage (on the device, off the device, or some combination thereof) that contains instructions that when executed by the device causes the device to perform at least a subset of the operations described above in FIGS. 2-7.

The various embodiments described above may be implemented in various systems that display content (content display systems) and the content display systems may be incorporated in various devices.

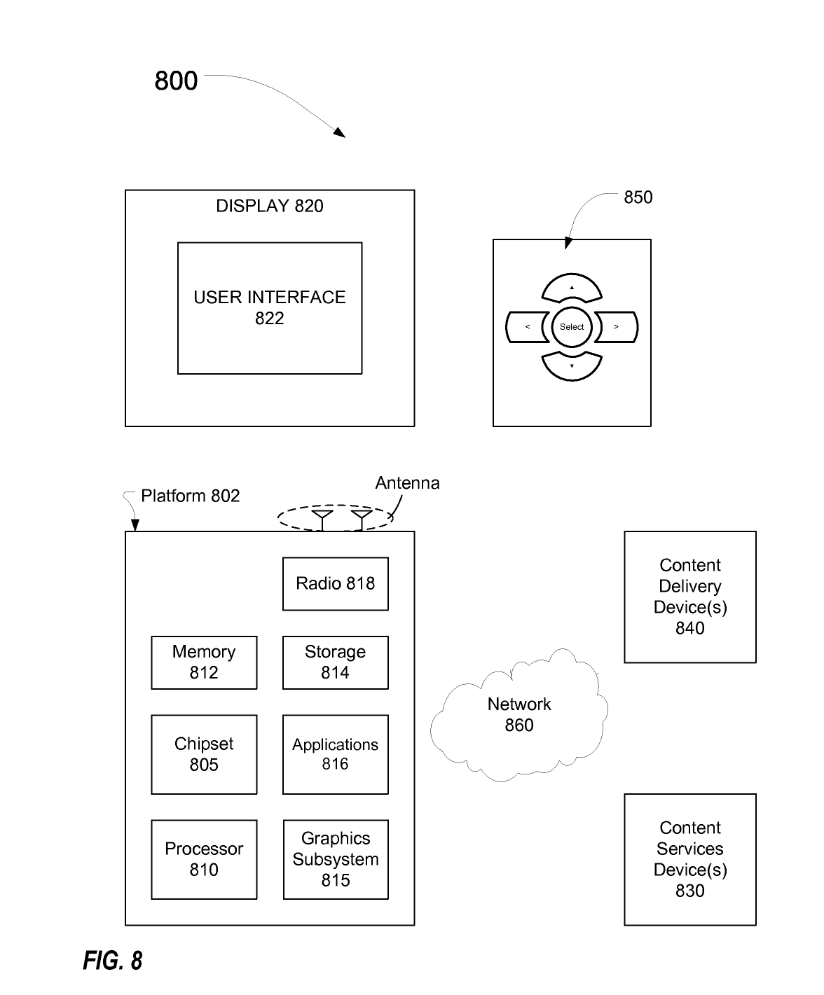

FIG. 8 illustrates an example content display system 800. The system 800 may be a media system although it is not limited to this context. The system 800 may be incorporated into, for example, a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, the system 800 comprises a platform 802 coupled to an external display 820. The platform 802 may receive content from a content device such as content services device(s) 830, content delivery device(s) 840 or other similar content sources. A navigation controller 850 comprising one or more navigation features may be used to interact with, for example, the platform 902 and/or the display 820.

In embodiments, the platform 802 may comprise any combination of a chipset 805, a processor 810, memory 812, storage 814, a graphics subsystem 815, applications 816 and/or a radio 818. The chipset 805 may provide intercommunication among the processor 810, the memory 812, the storage 814, the graphics subsystem 815, the applications 816 and/or the radio 818. The chipset 805 may, for example, include a storage adapter (not depicted) capable of providing intercommunication with the storage 814.

The processor 810 may be implemented as Complex Instruction Set Computer (CISC) or Reduced Instruction Set Computer (RISC) processors, x86 instruction set compatible processors, multi-core, or any other microprocessor or central processing unit (CPU). In embodiments, the processor 810 may comprise dual-core processor(s), dual-core mobile processor(s), and so forth.

The memory 812 may be implemented as a volatile memory device such as, but not limited to, a Random Access Memory (RAM), Dynamic Random Access Memory (DRAM), or Static RAM (SRAM).

The storage 814 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, the storage 814 may comprise technology to increase the storage performance or enhanced protection for valuable digital media when multiple hard drives are included, for example.

The graphics subsystem 815 may perform processing of images such as still or video for display. The graphics subsystem 815 may be a graphics processing unit (GPU) or a visual processing unit (VPU), for example. An analog or digital interface may be used to communicatively couple the graphics subsystem 815 and the display 820. For example, the interface may be any of a High-Definition Multimedia Interface, DisplayPort, wireless HDMI, and/or wireless HD compliant techniques. The graphics subsystem 815 could be integrated into the processor 810 or the chipset 805. The graphics subsystem 815 could be a stand-alone card communicatively coupled to the chipset 805.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

The radio 818 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, the radio 818 may operate in accordance with one or more applicable standards in any version.

In embodiments, the display 820 may comprise any television type monitor or display. The display 820 may comprise, for example, a computer display screen, touch screen display, video monitor, television-like device, and/or a television. The display 820 may be digital and/or analog. In embodiments, the display 820 may be a holographic display. Also, the display 820 may be a transparent surface that may receive a visual projection. Such projections may convey various forms of information, images, and/or objects. For example, such projections may be a visual overlay for a mobile augmented reality (MAR) application. Under the control of one or more software applications 816, the platform 802 may display the user interface 822 on the display 820.

In embodiments, the content services device(s) 830 may be hosted by any national, international and/or independent service and thus accessible to the platform 802 via the Internet, for example. The content services device(s) 830 may be coupled to the platform 802 and/or to the display 820. The platform 802 and/or the content services device(s) 830 may be coupled to a network 860 to communicate (e.g., send and/or receive) media information to and from the network 860. The content delivery device(s) 840 also may be coupled to the platform 802 and/or to the display 820.

In embodiments, the content services device(s) 830 may comprise a cable television box, personal computer, network, telephone, Internet enabled devices or appliance capable of delivering digital information and/or content, and any other similar device capable of unidirectionally or bidirectionally communicating content between content providers and the platform 802 and/or the display 820, via the network 860 or directly. It will be appreciated that the content may be communicated unidirectionally and/or bidirectionally to and from any one of the components in the system 800 and a content provider via the network 860. Examples of content may include any media information including, for example, video, music, medical, gaming information, and so forth.

The content services device(s) 830 receives content such as cable television programming including media information, digital information, and/or other content. Examples of content providers may include any cable or satellite television or radio or Internet content providers. The provided examples are not meant to limit embodiments of the invention.

In embodiments, the platform 802 may receive control signals from navigation controller 850 having one or more navigation features. The navigation features of the controller 850 may be used to interact with the user interface 822, for example. In embodiments, the navigation controller 850 may be a pointing device that may be a computer hardware component (specifically human interface device) that allows a user to input spatial (e.g., continuous and multi-dimensional) data into a computer. Many systems such as graphical user interfaces (GUI), televisions and monitors allow the user to control and provide data to the computer or television using physical gestures.

Movements of the navigation features of the controller 850 may be echoed on a display (e.g., display 820) by movements of a pointer, cursor, focus ring, or other visual indicators displayed on the display. For example, under the control of software applications 816, the navigation features located on the navigation controller 850 may be mapped to virtual navigation features displayed on the user interface 822, for example. In embodiments, the controller 850 may not be a separate component but integrated into the platform 802 and/or the display 820. Embodiments, however, are not limited to the elements or in the context shown or described herein.

In embodiments, drivers (not shown) may comprise technology to enable users to instantly turn on and off the platform 802 like a television with the touch of a button after initial boot-up, when enabled, for example. Program logic may allow the platform 802 to stream content to media adaptors or other content services device(s) 830 or content delivery device(s) 840 when the platform is turned “off” In addition, the chipset 805 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in the system 800 may be integrated. For example, the platform 802 and the content services device(s) 830 may be integrated, or the platform 802 and the content delivery device(s) 840 may be integrated, or the platform 802, the content services device(s) 830, and the content delivery device(s) 840 may be integrated, for example. In various embodiments, the platform 802 and the display 820 may be an integrated unit. In various embodiments, the display 820 and the content service device(s) 830 may be integrated, or the display 820 and the content delivery device(s) 840 may be integrated, for example. These examples are not meant to limit the invention.

In various embodiments, the system 800 may be implemented as a wireless system, a wired system, or a combination of both. When implemented as a wireless system, the system 800 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, the system 800 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

The platform 802 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 8.

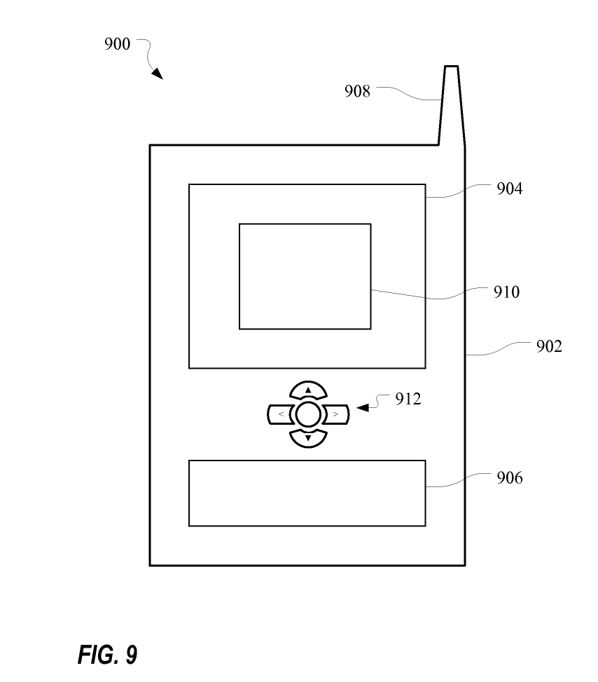

As described above, the system 800 may be embodied in varying physical styles or form factors. FIG. 9 illustrates embodiments of a small form factor device 900 in which the system 800 may be embodied. In embodiments, for example, the device 900 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example the mobile computing device may be utilized in a vehicle (e.g., car, truck, van). The in-vehicle device may provide information and/or entertainment to occupants of the vehicle (in-vehicle infotainment (IVI) device). The IVI device may utilize power from the vehicle as an external power source in addition to, or in place of, an internal battery powering the device.

In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

The device 900 may comprise a housing 902, a display 904, an input/output (I/O) device 906, and an antenna 908. The device 900 also may comprise navigation features 912. The display 904 may comprise any suitable display unit for displaying information appropriate for a mobile computing device. The I/O device 906 may comprise any suitable I/O device for entering information into a mobile computing device. Examples for the I/O device 906 may include an alphanumeric keyboard, a numeric keypad, a touch pad, input keys, buttons, switches, rocker switches, microphones, speakers, voice recognition device and software, and so forth. Information also may be entered into the device 900 by way of microphone. Such information may be digitized by a voice recognition device. The embodiments are not limited in this context. The device 900 may include a battery (not illustrated) to provide power thereto. The battery may be located in the device 900 (e.g., within the housing 902) and/or may be remote from the device 900 (e.g., vehicle battery utilized for IVI device).

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed:

1. An apparatus comprising
a viewing configuration detector to collect data for a viewing area of a consumer electronics device and determine viewing configuration based on the collected data; and
a dynamic user interface controller to determine a perceived appropriate configuration for the content being presented by the consumer electronics device based on the viewing configuration and if necessary modify the configuration of the content, wherein the modifying is done without receiving input to make the change from a user, and wherein the modified configuration may conserve power consumption of the consumer electronic device and save battery life if the consumer electronic device is battery operated.

2. The apparatus of claim 1, wherein the modifying the configuration of the content includes reducing the luminosity of the content, wherein the reduced luminosity conserves power.

3. The apparatus of claim 1, wherein the modifying the configuration of the content includes dimming or turning off a display of the consumer electronics device to conserve power.

4. The apparatus of claim 1, wherein the modifying the configuration of the content includes modifying at least some subset of text size, window configuration, viewing angle, and display quality.

5. The apparatus of claim 1, wherein the dynamic user interface controller is further to determine a perceived appropriate configuration for user interface mode being used with the consumer electronics device based on the viewing configuration and if necessary modify the configuration of the user interface, wherein the modifying is done without receiving input to make the change from the user.

6. The apparatus of claim 5, wherein the configuration of the user interface includes at least some subset of touch screen, voice activated, and remote control.

7. The apparatus of claim 1, wherein the viewing configuration detector includes a light transmitter to transmit light in direction of the user, a light receiver to receive reflected light, and a distance determiner to determine how far the user is from the consumer electronics device based on input from the light transmitter and the light receiver.

8. The apparatus of claim 7, wherein the viewing configuration detector further includes a location determiner to determine location of the user with respect to the consumer electronics device based on input from the light transmitter and the light receiver.

9. The apparatus of claim 1, wherein the viewing configuration detector includes a camera to capture images of the viewing area and image recognition functionality to detect the user and different attributes associated therewith.

10. A consumer electronics device comprising
a display to present content;
a viewing configuration detector to collect data for a viewing area of the display and determine viewing configuration based on the collected data; and
a dynamic user interface controller to determine if current configuration for the content being presented on the display should be modified based on the viewing configuration and modify the configuration of the content when modification is determined to be appropriate, wherein the modifying is done automatically without receiving directions from a user, and wherein the modyifying includes reducing the luminosity to conserve power.

11. The device of claim 10, wherein the viewing configuration detector includes
a light transmitter to transmit light in direction of the user;
a light receiver to receive reflected light; and
functionality to determine how far the user is from the consumer electronics device based on input from the light transmitter and the light receiver.

12. The device of claim 11, wherein the functionality is further to determine location of the user with respect to the consumer electronics device based on the input from the light transmitter and the light receiver.

13. The device of claim 10, wherein the viewing configuration detector includes
a camera to capture images of the viewing area; and
image recognition functionality to detect the user and different attributes associated therewith from the captured image.

14. The device of claim 10, wherein the modifying further includes dimming or turning off the display to conserve power.

15. The device of claim 10, wherein the modifying further includes modifying at least some subset of text size, window configuration, viewing angle, and display quality.

16. The device of claim 10, wherein the dynamic user interface controller is to determine the modifications to the current configuration of the content based on criteria defined by the user.

17. The device of claim 10, wherein the dynamic user interface controller is to determine the modifications to the current configuration of the content based on application of heuristics.

18. The device of claim 10, wherein the dynamic user interface controller is further to determine if current configuration for user interface associated with the device should be modified based on the viewing configuration and modify the configuration of the user interface when modification is determined to be appropriate.

19. A system comprising
a consumer electronics device including
a display to present content;
a camera to capture images of a viewing area for the display;
image recognition functionality to generate a first viewing configuration from the captured image, wherein the first viewing configuration includes identification of users in the viewing area and different attributes associated therewith;
a communications interface to receive a second viewing configuration from an external source;
a user interface to receive commands from a user, wherein the commands includes configuring the content; and
a dynamic user interface controller to determine if current configuration for the content being presented on the display should be modified to conserve power or enhance user experience based on some combination of the first viewing configuration and the second viewing configuration and modify the configuration of the content when modification is determined to be appropriate, wherein the modifying is done automatically without receiving commands from the user via the user interface;
a light transmitter to transmit light in direction of the user;
a light receiver to receive reflected light; and
a processor to generate the second viewing configuration based on input from the light transmitter and the light receiver, wherein the second viewing configuration includes distance and location of the user.

20. The system of claim 19, wherein the modifying includes at least some subset of reducing the luminosity of the display, dimming the display, or turning off the display to conserve power.
